(19) United States
(12) Patent Application Publication
(10) Pub. No.: US 2018/0093908 A1
(43) Pub. Date: Apr. 5, 2018

(54) Enhanced Membrane Bioreactor Process for Treatment of Wastewater

(71) Applicant: Aquatech International, LLC, Canonsburg, PA (US)

(72) Inventors: Ravi Chidambaran, Canonsburg, PA (US); Pavan Raina, Pune (IN); Nitin Chandan, Maharashtra (IN)

(21) Appl. No.: 15/563,172

(22) PCT Filed: Mar. 31, 2016
(86) PCT No.: PCT/US2016/025331

§ 371 Date: Sep. 29, 2017

Related U.S. Application Data
(60) Provisional application No. 62/191,748, filed on Jul. 13, 2015.

(30) Foreign Application Priority Data
Mar. 31, 2015 (IN) 919/DEL/2015

(51) Int. Cl. C02F 3/08; C02F 3/12; C02F 1/44; C02F 3/10; C02F 3/20; B01D 65/02; B01D 65/08

(52) U.S. Cl. CPC C02F 3/08; C02F 3/1268; C02F 1/444; C02F 3/108; C02F 3/20; B01D 2315/06; B01D 65/08; C02F 2303/22; B01D 2321/30; B01D 2321/26; B01D 65/02

(57) ABSTRACT

Embodiments provide an apparatus and method for a membrane bioreactor process including a media in the water circulation module. Along with air supplied from bottom of the module the media components are kept in dynamic condition between the gaps to scrub the membrane surface area to it clean in-situ. Continued cleaning of the membrane surface results in benefits of reduced/no physical and chemical cleaning requirement, high flux, low TMP, and reduced frequency of chemical cleaning. The use of highly porous polymeric media having large internal surface area provides the advantage of retention of microbiological culture for a longer time without any disturbance causing an upset condition while increasing the biological loading and treatment capacity of the reactor.

### CROSS-REFERENCE TO RELATED APPLICATIONS

This application claims priority to Indian Application No. 919/DEL/2015, filed on Mar. 31, 2015, and to U.S. Provisional Patent Application No. 62/191,748 filed on Jul. 13, 2015. Both of those applications are incorporated by reference herein.

### BACKGROUND OF THE INVENTION

### Field of the Invention

Embodiments relate to improvement of membrane bioreactor process by addition of polymeric media along with membrane module(s). This may reduce membrane fouling, improve flux, and reduce overall footprint and cost of the treatment system.

### Background of the Related Art

Membrane bioreactor (“MBR”) technology is a well-established wastewater treatment process. It is accepted for use with municipal as well as industrial wastewater treatment. The technology has many advantages, including small footprint, exceptional organic removal and very good consistent effluent quality. Different types of polymeric membranes like flat membrane, hollow fiber and tubular type membranes may be used in the process. The membrane is the heart of MBR process, and correct operation and maintenance of membrane and the biological process is extremely important for longterm sustainable performance.

In a conventional MBR process operates in a cyclic process and a specific time for relaxation and backwashing provides the best results in terms of sustained flux and trans-membrane pressure (“TMP”). Maintaining a consistent flux requires a relaxation period for a minute after every 9-10 minutes of operation. Backwashing of the membrane with the permeate water and periodical chemical cleanings are imperative. During the relaxation period and backwashing process the permeate production from the membrane modules is stopped for certain time. Because of this the membrane system needs to be upsized to meet water production needs during the time remaining for operation. Also during the 9 minute operation in a cycle, there is a decline in the flux. This process affects overall productivity and efficiency of system. The requirement of periodic chemical cleaning increases operational cost, and the use of frequent chemicals for cleaning may reduce the membrane life.

In addition, current MBR is limited by the flux and needs to be operated at lower flux as increase in the flux increases solid loading at the membrane surface hence membrane gets fouled and thereby requires frequent cleaning. Furthermore, during the 9-10 minutes operating period we may see decline in the flux, which is recovered during the relaxation period and gradually when this process continues the recovery of flux may not always happen and the system requires chemical cleaning, which results in loss of productivity.

Existing membrane bioreactor systems have limitations related to the content of Mixed Liquor Suspended Solids (“MLSS”). Typically a system gives best results within a certain band of MLSS values. Especially handling of low MLSS conditions is quite difficult due to increases of number of filamentous bacteria in sludge. The filamentous bacteria have poor filtration characteristics foul the membrane surface immediately. Simple air bubble impact may not able to clean the membrane surface, and with time it leads to thick solids layer formation over the membrane surface. In a conventional membrane bioreactor, when operation is suspended, there is a possibility that sludge may get washed out, and microorganisms developed for removal of certain organic compound may get removed from the system. This leads to further system upset and reduces productivity.

While the MBR process works well, it has its limitations as described above. There is another process known as Moving Bed Bio Reactor (MBBR), which is used to improve the performance of activated sludge. This process works through attached growth on the huge surface area offered by the media in place. This reduces the hydraulic retention time and consequently the reactor volume reduces. But in this process one does not achieve the quality of water that is achievable through a MBR process, and the chances of upset conditions disrupting the steady state conditions cannot be totally ruled out. The conventional MBBR uses plastic media like PVC or polypropylene, which are hydrophobic in nature and water or bio mass cannot penetrate through the media. So the impact of media is largely a surface phenomenon, which takes place on the surface area provided by the media.

### BRIEF SUMMARY OF THE INVENTION

It would be helpful to provide a more efficient, higher-performing MBR process. In embodiments presented herein, conventional MBR process is made efficient in performance by integrating with a non-bio degradable media, which is kept dynamic and fluidized within the membrane system to enhance the performance of both the biological process and the membrane material. Typically the media is a polymer media. In one embodiment the media comprises crosslinked polyvinyl alcohol (PVA) spheres. In another embodiment the media consists of crosslinked PVA spheres. This process can use other porous polymeric material in porous structures. These may be, for example, polyurethane, PVDF, poly-lactic acid, poly acrylic acid, polymethacrylate, polyethylene glycol, natural biopolymers like alginates, chitosan, and Carboxy methylcellulose, etc, or other porous polymers where the bacteria can be cultivated and encapsulated water and organic material which act as food can penetrate through the polymeric structure due to the pore size and void space available therein.

This media is added in a wastewater treatment system along with an MBR unit. The gaps between the membranes of MBR are kept such that these beads can easily move and flow through the gaps with air in system and scrub the membrane surface, and keep the membrane surface clean all the time. This is in contrast with the operation of air bubbles, which typically do not assist with cleaning of the membrane surface. The polymeric media remains circulating within the system as the permeate is drawn through the membranes and any sludge removal happens through a recirculation pump with has a suction strainer, which does not allow the media to come out but allows the sludge to drain out for filtration. The filtered mother liquor is circulated back into the reactor. The media can also be encapsulated within the module by caging the module with a wire mesh such that media cannot move to the bulk solution outside the membrane modules in the bio-reactor.

The soft media, which accommodates millions of bacteria, treats chemical oxygen demand (“COD”) and in a fluidized dynamic motion removes foulants from the membrane surface or prevents the fouling process from getting initiated. The media keeps the membrane surface clean without the need for providing any rest time or back wash, and at the same time allows the membrane to produce higher volume of permeate at higher flux. Therefore the overall productivity of membrane and the biological process improves by 25-40%. The rate of biological digestion of organics is also enhanced by the same margin while reducing sludge production by more than 40-50%. The media has a three dimensional role, because it is not the surface phenomenon—the inside porous structure is also activated by bacteria, which plays an important role in enhancing the reaction kinetics and reducing the sludge mass generated due to high density of active bacteria.

Inclusion of the media also offers advantages of conditioning the sludge such that the sludge volume will reduce due to compactness of the sludge. This facilitates nitrification due to the presence of nutrients and formation of nitrifying bacteria inside the media. For a given membrane area one obtains higher permeate due to non-stop permeate production at a higher flux and without any loss of flux. Consequently there is a reduction in the cost of power, which reduces the overall operating cost.

The process also works in through elegant combination of conventional MBBR and MBR in a single operating unit while maintaining the advantages of both processes and also giving unexpected results on overcoming their disadvantages i.e. delivering MBR quality water which is possible in MBBR and not having fouling problems encountered in MBR. Also the unexpected results are seen in eliminating rest time or cyclic operation where production needs to be sacrificed, at a lower TMP without suffering any flux loss and simultaneously reducing sludge production. This approach also enables increase in organic loading without compromising treatment capacity or quality.

Embodiments may have, but are not required to have, one or more of the following aspects, where comparisons are made to conventional MBR systems:

1. More productivity due to reduced or no physical cleaning required;
2. Low frequency of chemical cleaning, which increases membrane life;
3. Reduced sludge handling cost;
4. Improved flux from membrane module;
5. Less membrane area requirement;
6. Less foot print;
7. Low power consumption;
8. Consistent product quality;
9. No loss of performance due to up set condition as polymeric bio media holds microorganism in its porous structure;
10. Low operating cost.

### BRIEF DESCRIPTION OF THE FIGURES

FIG. 1 shows a flow scheme for an embodiment of the invention.

FIG. 2 shows an internal cross sectional structure of a single sphere of a typical media, which shows a highly porous structure.

FIG. 3 compares the appearance of fresh and activated media.

FIG. 4 shows a scanning electron micrograph (“SEM”) view of activated media.

FIG. 5 shows operation of a typical membrane module according to an embodiment of the invention.

FIG. 6 shows results from operation of an enhanced membrane bioreactor at variable flux.

FIG. 7 shows results from operation of an MBR without media as reported herein.

FIG. 8 shows operation at 30 LMH flux with the inclusion of media.

FIG. 9 shows COD reduction through operation of an MBR with media.

FIG. 10 shows further results of COD loading in an enhanced MBR as reported herein.

### DETAILED DESCRIPTION OF THE INVENTION

Typically combination of membrane filtration and suspended biological activity is known as a membrane bioreactor. Membrane bioreactor technology is widely used for treatment of municipal and industrial wastewater. MBR process could produce effluent of high quality, which can be discharged or recycled/reused. However membrane bioreactor technology has an inherent flaw, namely membrane fouling. Despite its contribution to solid rejection, membrane fouling has been generally recognized as the cause of permeate flux decline requiring cyclic operation and frequent physical/chemical cleaning. Membrane fouling is largely dependent on process parameters and biological condition. Because of operational limitations, it is necessity to improve conventional membrane bioreactor process with the following objectives, which may or may not be achieved, of:

1. Reduced membrane fouling;

2. Improved hydraulic flux;

3. Reduced or removed physical cleaning;

4. Reduced chemical cleaning;

5. Increased capacity of biological system in terms of COD load handling;

6. Protected bio culture for consistent performance of biological system;

Embodiments as presented herein may have one or more of the above advantages, thereby enhancing membrane bioreactor process for its wide application for treatment of municipal and industrial wastewater.

Generally, embodiments are presented herein are invention is related to an aerobic submerged membrane bioreactor process. A membrane bioreactor process may be made more efficient and user-friendly by integrating a membrane bioreactor process with a media capable of serving as a structure for biological growth.

A preferred media for use in embodiments of the invention is cross-linking polyvinyl alcohol. This may be prepared, for example, by a copolymerization process or cross-linking of PVA with PVA in a boric acid medium. Typically components of the media are spherical or nearly spherical. In some embodiments the size of the media is 2 to 8 mm, preferably an average of 3 mm. The size can be varied and customized for certain sizes and configuration of MBR membranes. The criteria for selection mainly depends on style of membranes that is hollow fiber of plate type. The size of the media is based on allowing free movement of media within the reactor volume and ability to keep it fluidized while allowing access to most of the membrane surface to allow it to scrub the membrane constantly. Typically the beads are highly porous, having an interior surface area of between 3000 to 5000 m²/m³.

We provide a system including a submerged membrane module along with the media reported herein used for treatment of wastewater by an aerobic process. In a specific embodiment, a membrane module with specific gaps between plates is being used for filtration of sludge and water. These inter-plate gaps may be, for example 2 to 10 mm, preferably 4-6 mm.

Along with air supplied from bottom of the module the media is kept in dynamic condition between the gaps to scrub the membrane surface area to clean it in-situ. Continued cleaning of membrane surfaces by the media results in benefits of requirement of no cyclic cleaning, reduced or even no physical and chemical cleaning requirement, high flux, low TMP and reduced frequency of chemical cleaning.

The use of highly porous media having large internal surface area provides the advantage of retention of microbiological culture for a longer time without disturbances causing an upset condition. Due to the presence of large numbers of microorganism like aerobic bacteria, protozoa, metazoan, filamentous bacteria and others the biodegradation of organic compound present in wastewater gets accelerated. Bacteria are able to reside within the porous polymeric media and able to develop the appropriate mixed culture which accelerate the metabolism process of the organic materials. In addition, the sludge generation gets reduced to about 50% of that produced by a conventional MBR process due to autolysis taking place in the reactor. This reduces solid sludge waste generation and reduces sludge handling cost. Overall efficiency of biological system gets enhanced with the combination of membrane and polymeric media in single aerobic reactor.

The following describes an embodiment of the invention. In typical embodiments a membrane module may be prepared as reported in U.S. Pat. No. 8,753,509, “Advanced Filtration Device for Water and Wastewater Treatment,” which is incorporated by reference herein. For an experimental trial a bioreactor of 150 liters capacity was made. Flat sheet ultrafiltration polyvinylidene fluoride (PVDF) cartridges supplied by Qua group were used for the trial. A membrane module was prepared placing membrane plate one by one with specific gap of 3 to 6 mm in between. Two membrane modules having surface area of 1.8 m² are kept one above other. Total surface area of module was 3.6 m². Air diffusers were provided at the bottom of the module to supply air. The air supplied by diffusers was used for both purposes; biological supply as well as circulating media within the reactor and in between the membrane gaps. A vacuum or permeate pump was provided for collection of product from the membrane module.

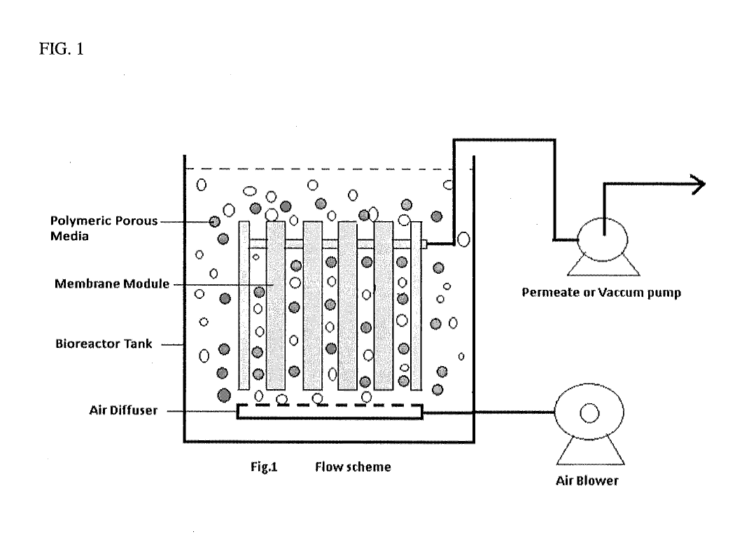

Simulated feed water having COD and nutrient was used for study. A feed pump with flow meter was provided for supply of feed water to the system. This was tested continually at different operational and process parameters. Analysis of feed and product water was done for Chemical Oxygen Demand (COD), Biological Oxygen Demand (BOD), pH, and alkalinity. Biological parameters like Mixed Liquor Suspended Solids (MLSS), Hydraulic Retention Time (HRT), Solid Retention Time (SRT) and Sludge Volume Index (SVI) were measured and monitored to control biological system. Microbiological analysis was performed by an external laboratory by colony formation method. Turbidity of product water was measure by HACH 2100N Turbidity meter. A flow scheme for this trial is shown in FIG. 1 and is generally representative of embodiments as reported herein.

In this trial media was added to the reactor equivalent to 18% of reactor volume along with activated sludge. The activated sludge was collected from an operating sewage treatment plant. Polymeric media and activated sludge were added to reactor to initiate activation for the first time. In other embodiments of the invention media may be added in amounts between 15-25% of the reactor volume, 10-30% of the reactor volume, or 16-20% of the reactor volume.

Prior to operation the media and sludge were aerated for some time with addition of food and nutrient to activate the media. For 8-10 days. a membrane cartridge was submerged in the bioreactor, and the system was connected to the vacuum assembly. The reactor was fed with simulated water having a character equivalent to municipal wastewater.

Operation of the reactor began, with an effort made to maintain certain biological parameters like Mixed Liquor Suspended Solids (MLSS) and Chemical Oxygen Demand (COD) loading, tested at different hydraulic flux. During testing membrane performance was studied in terms of change in Trans Membrane Pressure (TMP) and product turbidity while bio degradation performance was judged by COD and BOD rejection from the system.

In a typical embodiment, an enhanced media-enabled MBR has two main components: media and at least one membrane module. Detail description of both is given below

Media

Growth media referred to herein is a porous polymeric media. Typically this media includes a plurality of units of PVA as base polymer that is cross-linked. It is spherical or generally spherical in shape. The highly porous media holds >90% moisture in its structure. Media can accommodate millions of bacteria in porous structure. When added to the wastewater system, the media is activated with biomass in the environment it is exposed to and resides in. It acts as a media attached growth process. Once particular microbial activity develops in the porous area, media itself is capable of treating the wastewater and reduce COD and BOD from it. It will be appreciated that the media is not present as a single, agglomerated unit, but is instead present as a plurality of tiny units.

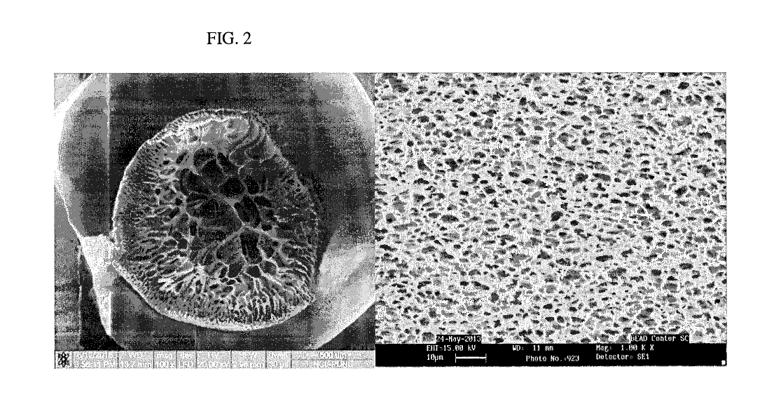

As microorganisms get embedded into the media, bacteria remain protected from washout or removal from system by upset conditions. Media can be fluidized and can become dynamic in aerated or agitated environment. As the media remains in fluidized condition within the membrane system or between gaps of membrane, it continually scrubs the membrane surface, which helps in removal of thin sludge layer formed over the media during filtration process. This results in in-situ cleaning of the membrane surface and avoids fouling on the membrane surface is eliminated or reduced significantly. So the membrane remains virtually clean all the time in spite of residing in highly fouling environment. FIG. 2 shows an internal cross sectional structure of a single sphere of a typical media, which shows highly porous structure.

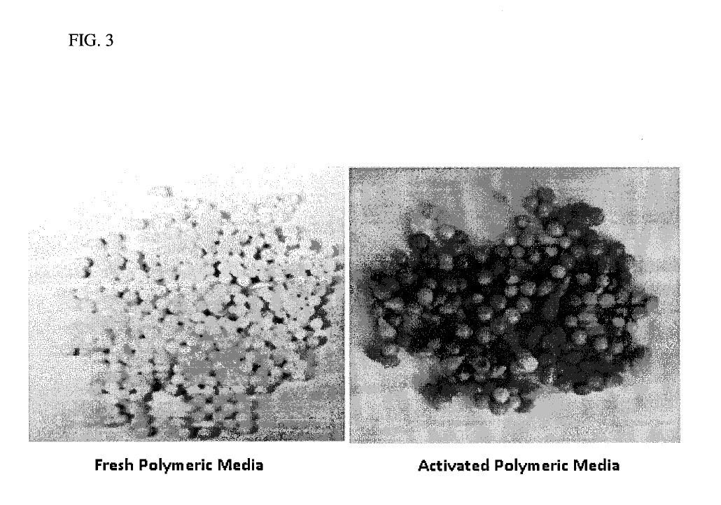

When the media gets fully activated in biological process, it converts into a brown color. SEM of activated media also indicates that a bio culture sits inside the porous structure. Microbiological analysis indicates presence of millions of bacteria. Fresh and activated media are compared in FIG. 3.

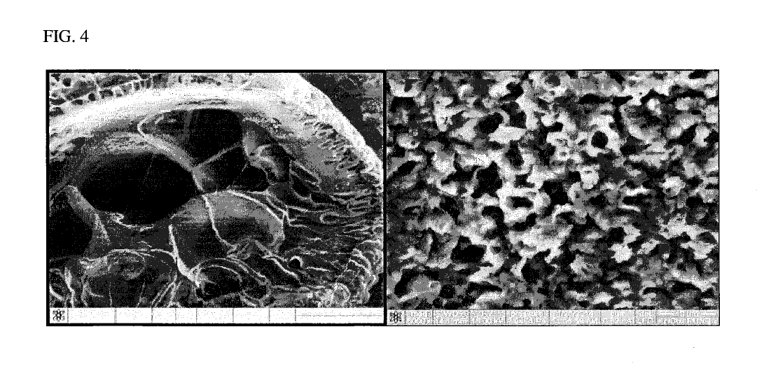

As shown in FIG. 3, brownish color media appear as activated spheres or beads, each of which holds bacterial culture in its porous structure. This culture will take part in the biological process. Because of high surface area and bio-active mass available with the media, the overall capacity of biological system in terms of COD loading is increased. A cross-sectional view of a unit of activated media, which appears in FIG. 4, shows that internal porous structure of the beads is occupied by the bacterial culture. Presence of substantial bacterial count can be observed from Scanning Electron micrograph (SEM).

Membrane Module

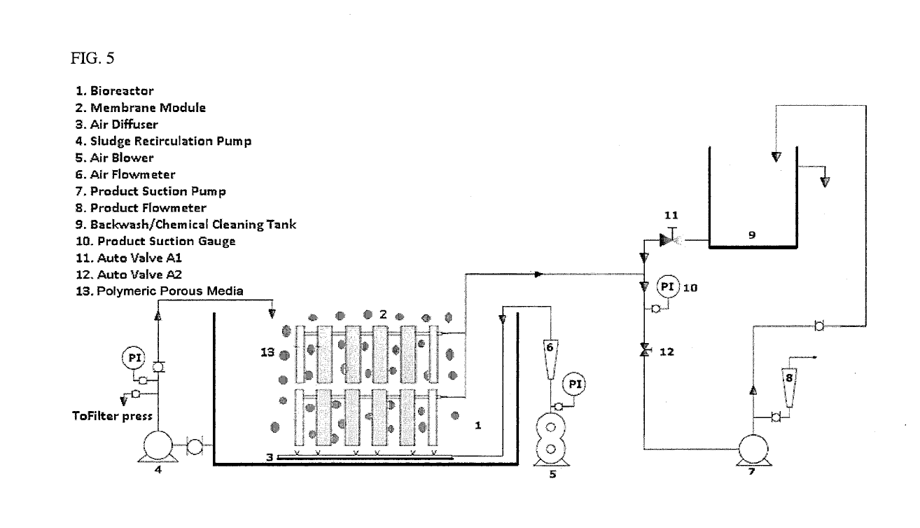

PVDF flat sheet ultrafiltration membrane was used for making submerged membrane module. Modules were prepared by assembly of number of membrane plates with specific gap of 2-10 mm in between. Module made for testing was having 10 plates. Two such modules are placed one above other. Modules were operated in outside-in mode, where water to be purified is drawn into the modules by a vacuum or suction pump. Product is collected by vacuum or suction pump from the modules. Operation of a typical module is shown in FIG. 5. As previously noted, more details on module operation are available in U.S. Pat. No. 8,753,509, “Advanced Filtration Device for Water and Wastewater Treatment.”

In a typical embodiment a module is operated in submerged mode. Reference numbers refer to FIG. 5. Membrane module (2) having air diffuser (3) at bottom was inserted in bioreactor tank (1). Air blower (5) was provided for aeration along with air flow meter (6) to monitor the airflow going to the module. Backwash or chemical cleaning tank (9) was placed above module for backwashing with product water to use during chemical cleaning. Product suction pump (5) was provided to draw permeate water from the membranes and also for transferring product. The product flow meter (8) was provided to monitor product flow coming out of the membrane module. The sludge recirculation pump (4) was provided for recirculation of sludge within tank and also to remove sludge from the tank and send it to press filter. The recirculation pump has a suction strainer and sludge is removed through a strainer, which allows the media to be retained within the reactor. The strainer size allows the sludge to come out. With pressure indicator (10) suction pressure required for module operation was monitored.

Detailed flow scheme of module operation is given in FIG. 5. The module operation was studied with and without media addition to the membrane tank. When media was not added to the tank, the module was operated with sequence of filtration and physical cleaning in a cyclic operational routine. During filtration cycle product suction pump (7) was in operation along with air blower (5). Product suction pump operates for 10 min. After each 10 min of filtration cycle 1.0 minute rest time was provided. During rest time product suction pump (7) was stopped and air blower (5) was kept operating to dislodge the sludge layer formed over membrane surface. One more type of physical cleaning was done to maintain membrane flux. The membrane was backwashed after each 2.0 hours of operation with product water. In this cleaning product water was passed from back side of the membrane surface from backwash tank (9) by gravity pressure for 5.0-10 min and after that 10 min residence time was given to permeate water from other side. During this cleaning, filtration from module was stopped and air blower was kept operating.

In a second trial media (13) was added to the bioreactor tank (1) at 15-25% of reactor volume. The system was operated with a changed sequence of operation without involving cyclic operation. Module was operated without rest time. Product suction pump (7) was operated continually. Also backwashing of the module was not performed because no decline in flux was seen. Backwash tank (9) was used as chemical cleaning tank to do maintenance cleaning of the module. As media (13) kept moving between membrane gaps of module (2) along with air, it kept the membrane surface clean. Due to this in-situ cleaning effect no physical, cleaning was needed to maintain flux. Also frequency of chemical cleaning gets reduced to ⅓ of the operation without media.

Results

As discussed above a laboratory reactor was made for trial and different trials were conducted to confirm process sustainability.

### Example-1 Operation at Variable Flux

In this trial we operated the Enhanced Membrane Bioreactor process at different hydraulic flux to understand the maximum critical flux process can be operated.

For this trial process was operated with simulated water having COD in the range of 200-300 mg/lit. Biological process parameters were maintained to achieve more than 90% COD and BOD reduction. During operation hydraulic flux was increased gradually from 20 lmh to 40 lmh and observed performance of reactor.

Operational Parameters
1. Continuous collection of product;
2. Variable flux operation;
3. No physical cleaning in terms of rest time or back wash;
4. Product collected under suction; and
5. Process parameters as shown in Table 1.

TABLE 1
Process parameters

| Reactor | Suction | | | Feed | Prod. | % COD | Prod. |
|---|---|---|---|---|---|---|---|
| MLSS | pressure | Flux | HRT | COD | COD | Reduction | Turbidity |
| Mg/lit | mmHg | LMH | Hrs | Mg/lit | Mg/lit | % | NTU |
| 1500-3000 | 30-80 | 20-40 | 4-8 | 315 | 18 | 94 | <0.1 |

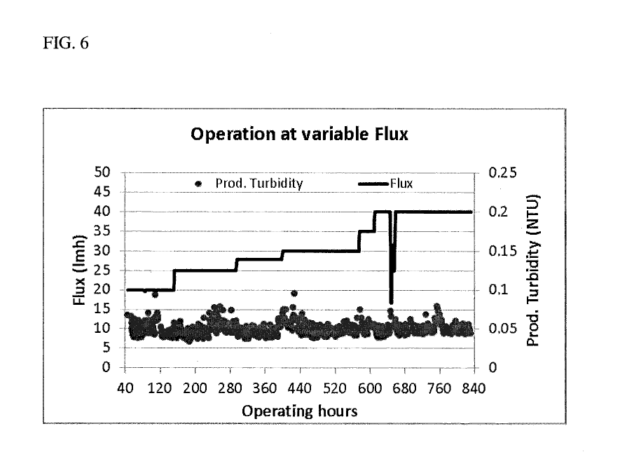

Table 1 and FIG. 6 indicate that an enhanced membrane bioreactor process can sustain variable flux range from 20 to 40 LMH by maintaining suspended solid rejection. COD rejection was observed to be >90% throughout the trial. Membrane flux was maintained without cyclic operation and any physical cleaning indicates enhanced biological treatment efficiency and also continuous and effective in-situ cleaning was taking place with the help of media. A drop in flux was observed after almost one month of operation. Flux was regained by preforming maintenance cleaning. Continuous operation could increase overall efficiency of system in terms of total water treated per day. With Enhanced Membrane bioreactor it is possible to achieve both Bio-degradation of wastewater along with high quality effluent and more productivity.

### Example 2 Operation at Low Suction Pressure

This trial was conducted to validate the low TMP operation of process. For this example two trials were conduced one with and other without media addition. One set was run without media addition to the bioreactor while another was run with addition of media to the system at biological condition. Both the systems were operated at same flux. The data was collected in terms of change of suction pressure and requirement of cleaning to maintain constant flux values.

Case 1—without Addition of Media to the System

TABLE 2
Operational parameters

| Reactor | Suction | Membrane | Feed | Prod. | COD | Prod. |
|---|---|---|---|---|---|---|
| MLSS | pressure | flux | COD | COD | Reduction | Turbidity |
| Mg/lit | mmHg | LMH | Mg/lit | Mg/lit | % | NTU |
| 5010 | 70-100 | 30 | 315 | 20 | 93 | <0.1 |

TABLE 3
Membrane cleaning

| | | |
|---|---|---|
| Physical cleaning | Rest time after each | Backwashing after |
| | 10 min of service | 2.0 hours of service |

| | |
|---|---|
| Chemical cleaning | After every 100 hour of service |

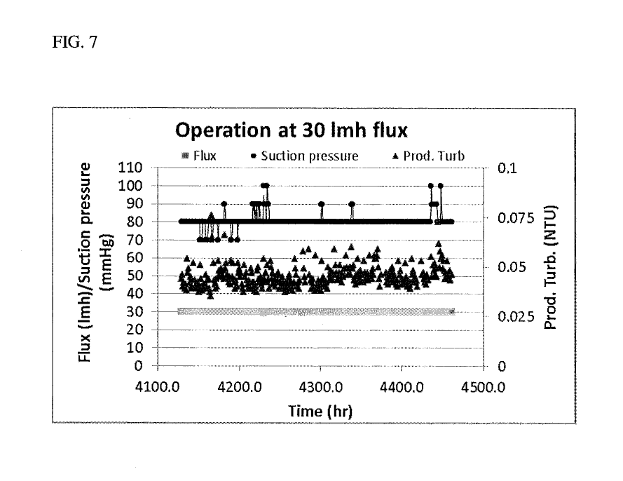

Table 2 and FIG. 7 indicate that to draw 30 LMH flux from membrane, 80 mmHg suction pressure is required. Due to membrane fouling, there is an increase in suction pressure up to 100 mmHg. To maintain the flux, rest time was provided after every 10 min of service cycle and to regain TMP chemical cleaning was done after every 100 hours of operation.

Case 2—with Media Addition to the Reactor

Media added to the reactor. Along with air, media was fluidized between the gap of the membrane. The system was operated at a constant 30 LMH flux as that of case-I.

TABLE 4
Operational parameters

| Reactor | Suction | Membrane | Feed | Prod. | COD | Prod. |
|---|---|---|---|---|---|---|
| MLSS | pressure | flux | COD | COD | Reduction | Turbidity |
| Mg/lit | mmHg | LMH | Mg/lit | Mg/lit | % | NTU |
| 4000 | 20 | 30 | 230 | 7.5 | 97 | <0.1 |

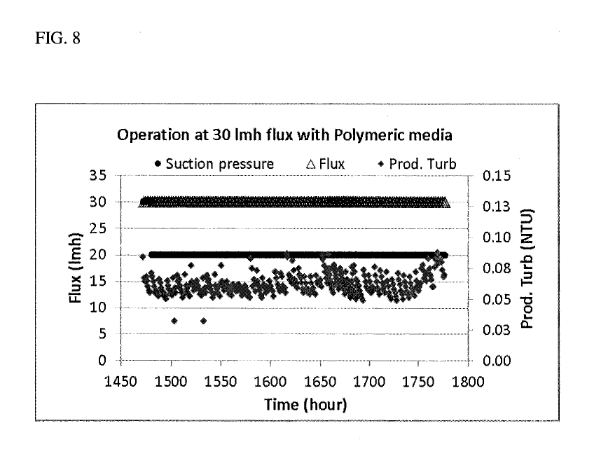

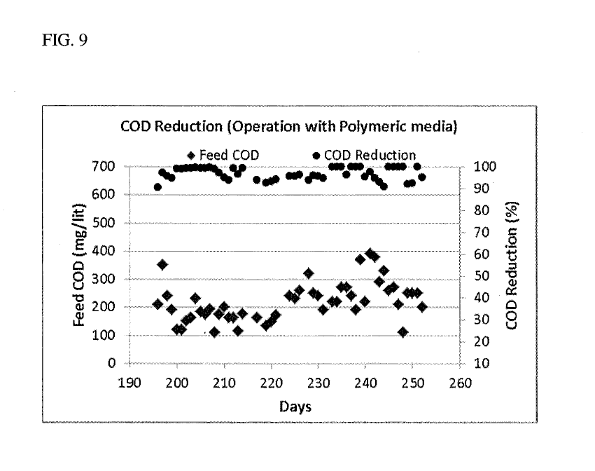

As shown in FIG. 8 and Table 4, Trans-membrane Pressure (TMP) required for drawing same flux from the membrane is significantly lower with addition of media; it reduces to 20 mmHg from 80. During operation no rest time was provided, there was no backwash or physical cleaning was performed to maintain flux. The consistency of flux could be due to in situ membrane cleaning by circulating media. No chemical cleaning was performed for one month of consistent operation; this decreased requirement for chemical cleaning reduces operational cost and also increases life of membrane. The product quality was maintained and an improvement in terms of COD reduction was observed due to enhanced biological treatment efficiency of the media. Results are shown in FIG. 9.

### Example-3 High COD Loading

Conventional activated sludge system operates at COD loading of 0.5 to 1.5 Kg/m³·day. Low COD loading of the process is due to limitation of excess sludge handling and difficulty experienced in keeping membranes clean in a highly fouling environment. In the conventional mode, high COD loading generates excess sludge, which has to be removed from the bioreactor to maintain biological parameters and process efficiency. The present innovation of porous media helps to increase loading capacity of the reactor. As media can hold very high amount of mass within its porous structure, the active media also take part in degradation of organic matter from wastewater. The presence of active biomass is confirmed by micro-biological testing which shows that millions of bacteria are present in each Bio-bead. Micro biological analysis results are shown in Table 5

TABLE 5
Micro biological analysis of Media

| Sr. No | Parameter | Unit | Value |
|---|---|---|---|
| 1 | Total bacterial count | Cfu/gm | 37 × 10⁸ |
| 2 | Nitrifier bacteria count | Cfu/gm | 51 × 10³ |

TABLE 6
Operational parameters

| Reactor | Operating | | | | COD |
|---|---|---|---|---|---|
| MLSS | flux | COD loading | Feed | Prod. COD | reduction |
| Mg/lit | lmh | Kg/m³Bio-bead · day | Mg/lit | Mg/lit | % |
| 3600 | 30-35 | 3-10 | 215 | 10 | 95.34 |

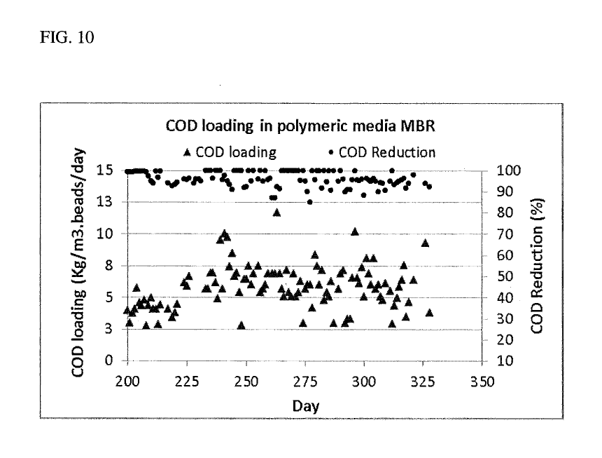

As shown in Table 6 and FIG. 10, a reactor was operated with maximum COD loading of 10 Kg.COD/m³ media/day. Reactor performance was maintained in terms of COD reduction even at higher COD loading. Embodiments of the present invention increase capacity of wastewater handling for a system. This will also reduce footprint of the system.

### Example 4 Reduced Sludge Generation

As noted above, media when used herein can hold millions of bacteria in its porous structure. During operation and continuous aeration the sludge formed in the process gets degraded by auto-lysis process. This process helps to reduce overall sludge formation in the system. In conventional activated sludge 0.5 Kg sludge formed per Kg of COD degraded. In embodiments reported herein sludge formation may be reduced by up to 50%. Sludge formed in Enhanced Membrane Bioreactor is 0.23 Kg VSS/Kg. COD degraded. Practical value of sludge generated was calculated based on actual Mixed Liquor Suspended Solids (MLSS) generated after degradation of specific amount of COD as shown in Table 7.

TABLE 7
Sludge generation in Enhanced Membrane Bioreactor

| | | Theoretical | Actual sludge | |
|---|---|---|---|---|
| Feed | | sludge | generation based on | |
| COD | HRT | generation | MLSS | Sludge generation |
| Mg/lit | hrs | gm/day | gm/day | Kg · VSS/Kg · COD |
| 120 | 6 | 23.33 | 9.25 | 0.238 |
| 250 | 6 | 97.20 | 43.66 | 0.270 |
| 277 | 6 | 53.85 | 23.68 | 0.264 |

### CONCLUSION

Overall study shows that, the present invention has potential to overcome limitation of the conventional membrane bioreactor system. Experimental data shows that use of media along with membrane for treatment of wastewater by aerobic process has a number of benefits. Due to the reduced or no physical cleaning required it is possible to operate process continually to increase productivity. As the sludge formation gets reduced by 50%, there is a reduction in sludge handling cost. The innovative process has lower capital as well as operating cost. As porous media hold microorganism in its structure, it helps to increase loading capacity of system. The presence of active biomass within the media structure has been proven by scanning electron micrograph and also by colony formation method. It is possible to operate an Enhanced Membrane Bioreactor at higher flux reducing the reduces overall foot print of the system. Product quality is maintained during various trials, indicating that consistent product quality can be achieved with added advantages.

We claim:

1. A membrane bioreactor, comprising:
a bioreactor tank,
a plurality of membrane modules, said membrane modules in fluid communication with a source of water to be purified and a permeate pump to remove purified water;\
a polymer media within the bioreactor tank, said polymer media capable of circulating around the membrane modules; and
an air diffuser, said air diffuser capable of assisting in circulation of the polymer media around the membrane modules.

2. The membrane bioreactor of claim 1, wherein said membrane surfaces are separated by a distance, such that the polymeric media can reach and scrub the membrane surface.

3. The membrane bioreactor of claim 1, wherein said polymer media is retained within the bioreactor tank or encapsulated within the membrane module.

4. The membrane bioreactor of claim 1, wherein said polymer media is present in an amount, by volume of the bioreactor tank, of 15-25%.

5. A method for increasing treatment capacity and membrane flux of a membrane bioreactor, comprising adding to the membrane bioreactor a polymer media within a tank of the membrane, bioreactor.

6. The method of claim 5, wherein the bioreactor operates with 1000 to 10000 mg/lit mixed liquor suspended solids.

7. The method of claim 5, further comprising scrubbing membrane surfaces of the membrane bioreactor by air-induced circulation of the polymer media.

8. A method for water purification through a membrane bioreactor, comprising:
providing water to be purified into a bioreactor tank,
said bioreactor tank comprising a plurality of membrane modules, said membrane modules in fluid communication with a source of water to be purified and a permeate pump to remove purified water, wherein said membrane modules are capable of filtering water as the water enters the membrane modules;
said bioreactor further comprising a polymer media within the bioreactor tank, said polymer media capable of circulating around the membrane modules; and
said bioreactor further comprising an air diffuser, said air diffuser capable of assisting in circulation of the polymer media around the membrane modules;
circulating the polymer media around the membrane modules; and
forcing water to be purified into the membrane modules, wherein the water entering the membrane modules is purified by filtration.

9. The method of claim 8, further comprising cleaning at least one surface of the membrane modules by agitation of the polymer media while enhancing the bio treatment capacity.

10. The method of claim 8, further comprising filtering sludge simultaneously with forcing water into the membrane modules.

11. The method of claim 8, further comprising treating water with a growth media attached to said bioreactor.

12. The method of claim 8, wherein the air diffuser provides air for media fluidization and biological degradation of organic compounds in water to be purified.

13. The method of claim 8, wherein the air diffuser circulates polymer media inside and outside of the membrane modules within the bio-reactor.

14. The method of claim 8, further comprising circulating water within the bioreactor consisting of membrane modules, through a recirculation pump.

15. The method of claim 8, wherein reduced or no physical cleaning or rest time is required to maintain a high membrane flux

16. The method of claim 8, wherein the membrane bioreactor has increased flux relative to an MBR process without polymer media.

17. The method of claim 8, wherein the membrane bioreactor has increased organic loading relative to a membrane bioreactor without polymer media.

18. The method of claim 8, wherein the circulating polymer media cleans the membrane modules in situ.

19. The method of claim 8, wherein the circulating polymer media cleans the membrane modules without damage to the membrane modules while the permeate is being drawn through the membranes.

20. The method of claim 8, wherein the membrane bioreactor, relative to a membrane bioreactor without polymer media, has at least one advantage selected from the group consisting of increased treatment capacity; reduced sludge volume; increased capacity through lack of cycling or rest time; reduced sludge production; and lower power cost
